(19) United States
(12) Patent Application Publication
(10) Pub. No.: US 2009/0101430 A1
(43) Pub. Date: Apr. 23, 2009

(54) POWER STEERING APPARATUS

(75) Inventors: Sosuke SUNAGA, Higashimatsuyama-shi (JP); Masaki WATANABE, Higashimatsuyama-shi (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/212,460

(22) Filed: Sep. 17, 2008

(30) Foreign Application Priority Data
Oct. 19, 2007 (JP) 2007-272340

(51) Int. Cl. B62D 5/06; B62D 5/09; G05D 7/00; F16K 31/02

(52) U.S. Cl. 180/421; 180/441; 180/426; 700/282; 251/129.15

(57) ABSTRACT

A power steering apparatus includes a steering shaft, a hydraulic power cylinder connected to the steering shaft and having first and second hydraulic chambers, a hydraulic pump that discharges a hydraulic pressure to the power cylinder, a control valve that supplies the hydraulic pressure from the pump to the first and second hydraulic chambers selectively in response to a steering operation, a steering shaft actuation unit driven by the hydraulic pressure from the pump to apply a torque to the steering shaft, a detection unit that detects information about a vehicle, driver and/or road, and a hydraulic control unit that supplies the hydraulic pressure from the pump to either of the control valve and the steering shaft actuation unit according to the detected information and, at the supply of the hydraulic pressure to the steering shaft actuation unit, increases the hydraulic pressure supplied to the steering shaft actuation unit.

### BACKGROUND OF THE INVENTION

The present invention relates to a power steering apparatus, particularly for use in a large automotive vehicle, to hydraulically assist a driver's steering force.

Japanese Laid-Open Patent Publication No. 2007-168674 discloses one type of power steering apparatus that includes a steering shaft, a control valve (rotary valve) disposed on the steering shaft, a power cylinder equipped with left and right hydraulic chambers and a hydraulic steering shaft actuation unit with left and right steering actuators. In the normal power steering mode, the control valve distributes a hydraulic pressure to the left and right hydraulic cylinder chambers so that the power cylinder produces a left or right steering assist force. In the automatic steering mode, either one of the left and right steering actuators becomes operated to rotate the steering shaft and thereby actuate the control valve indirectly to produce a steering assist force.

### SUMMARY OF THE INVENTION

In the above conventional power steering apparatus, the left and right steering actuators are always in communication with the left and right cylinder chambers. The hydraulic pressures in the left and right cylinder chambers are thus exerted on the left and right steering actuators even when the left and right steering actuators are not in operation (under the normal power steering mode). In such a case, the hydraulic pressures to the left and right steering actuators have to be drained. This results in pumping loss and incurs fuel efficiency deterioration and fluid temperature rise.

It is therefore an object of the present invention to provide a power steering device with less pumping loss.

According to a first aspect of the present invention, there is provided a power steering device, comprising: a steering shaft connected to a steering wheel; a hydraulic power cylinder connected to the steering shaft and having first and second hydraulic chambers; a hydraulic pump that discharges a hydraulic pressure to the power cylinder; a control valve that supplies the hydraulic pressure from the pump to the first and second hydraulic chambers selectively in response to a steering operation of the steering wheel; a steering shaft actuation unit driven by the hydraulic pressure from the pump to apply a torque to the steering shaft; a detection unit that detects information about at least one of a vehicle, a driver or a road; and a hydraulic control unit that supplies the hydraulic pressure from the pump to either of the control valve and the steering shaft actuation unit in accordance with the detected information, the hydraulic control unit being so structured as to, at the supply of the hydraulic pressure to the steering shaft actuation unit, increase the hydraulic pressure discharged from the pump to be supplied to the steering shaft actuation unit.

According to a second aspect of the present invention, there is provided a power steering device, comprising: a steering shaft connected to a steering wheel; a hydraulic power cylinder connected to the steering shaft and having first and second hydraulic chambers; a hydraulic pump that discharges a hydraulic pressure to the power cylinder; a control valve that supplies the hydraulic pressure from the pump to the first and second hydraulic chambers selectively in response to a steering operation of the steering wheel; a steering shaft actuation unit driven by the hydraulic pressure from the pump to apply a torque to the steering shaft; a detection unit that that detects information about at least one of a vehicle, a driver or a road; and a hydraulic control unit that supplies the hydraulic pressure from the pump to either of the control valve and the steering shaft actuation unit in accordance with the detected information, the hydraulic control unit narrowing down a hydraulic passage for communication from the hydraulic control unit to the control valve at the supply of the hydraulic pressure to the steering shaft control unit.

According to a third aspect of the present invention, there is provided a power steering device, comprising: a steering shaft connected to a steering wheel; a hydraulic power cylinder connected to the steering shaft and having first and second hydraulic chambers; a hydraulic pump that discharges a hydraulic pressure to the power cylinder; a control valve that supplies the hydraulic pressure from the pump to the first and second hydraulic chambers selectively in response to a steering operation of the steering wheel; a steering shaft actuation unit driven by the hydraulic pressure from the pump to apply a torque to the steering shaft; a detection unit that detects information about at least one of a vehicle, a driver or a road; and a hydraulic control unit that supplies the hydraulic pressure from the pump to either of the control valve and the steering shaft actuation unit in accordance with the detected information, the hydraulic control unit having a first hydraulic passage for communication to the steering shaft actuation unit and a second hydraulic passage for communication to the control valve and being capable of controlling the cross-sectional areas of the first and second hydraulic passages individually in such a manner that the cross-sectional area of the first hydraulic passage is made larger than the cross-sectional area of the second hydraulic passage at the supply of the hydraulic pressure to the steering shaft actuation unit.

The other objects and features of the present invention will also become understood from the following description.

### BRIEF DESCRIPTION OF THE DRAWINGS

FIG. 1 is a block diagram of a power steering apparatus according to a first embodiment of the present invention.

FIG. 2 is an axial section view of the power steering apparatus according to the first embodiment of the present invention.

FIG. 3 is an axial section view of a steering shaft assembly of the power steering apparatus according to the first embodiment of the present invention.

FIG. 4 is a radial section view of the steering shaft assembly, cut along line I-I of FIG. 3, according to the first embodiment of the present invention.

FIG. 5 is a radial section view of the steering shaft assembly, cut along line II-II of FIG. 3, according to the first embodiment of the present invention.

FIG. 6 is a radial section view of the steering shaft assembly, cut along line III-III of FIG. 3, according to the first embodiment of the present invention.

FIG. 7 is a radial section view of a left steering actuator of the power steering apparatus, taken along line IV-IV of FIG. 3, according to the first embodiment of the present invention.

FIG. 8 is a radial section view of a right steering actuator of the power steering apparatus, taken along line V-V of FIG. 3, according to the first embodiment of the present invention.

FIG. 9 is an axial section view of a hydraulic pressure regulation valve of the power steering apparatus according to the first embodiment of the present invention.

FIG. 10 is a perspective view of a spool of the pressure regulation valve according to the first embodiment of the present invention.

FIG. 11 is an enlarged view of a chamfered section of the spool according to the first embodiment of the present invention.

FIG. 12 is an axial section view of a hydraulic directional control valve of the power steering apparatus according to the first embodiment of the present invention.

FIG. 13 is a hydraulic circuit diagram of the power steering apparatus under normal power steering mode according to the first embodiment of the present invention.

FIG. 14 is a hydraulic circuit diagram of the power steering apparatus during right turn under automatic steering mode according to the first embodiment of the present invention.

FIG. 15 is a hydraulic circuit diagram of the power steering apparatus during left turn under automatic steering mode according to the first embodiment of the present invention.

FIG. 16 is a hydraulic circuit diagram of the power steering apparatus in the event of electric system failure according to the first embodiment of the present invention.

FIG. 17 is a diagram showing the control pressure characteristics of the pressure regulation valve according to the first embodiment of the present invention.

FIG. 18 is a flow chart for a main control program of the power steering apparatus according to the first embodiment of the present invention.

FIG. 19 is a flow chart for an automatic steering control program of the power steering apparatus according to the first embodiment of the present invention.

FIG. 20 is an automatic steering control judgment table of the power steering apparatus according to the first embodiment of the present invention.

FIG. 21 is a map showing the correlation between control response and solenoid current frequency under automatic steering mode according to the first embodiment of the present invention.

FIG. 22 is an enlarged view of a spool valve chamfered section of a power steering apparatus according to a second embodiment of the present invention.

FIG. 23 is an enlarged view of a spool valve chamfered section of a power steering apparatus according to a third embodiment of the present invention.

FIG. 24 is an enlarged view of a spool valve chamfered section of a power steering apparatus according to a fourth embodiment of the present invention.

### DESCRIPTIONS OF THE EMBODIMENTS

The present invention will be described in detail below with reference to first to fourth embodiments. In the following description, like parts and portions are designated by like reference numerals to avoid repeated explanations thereof.

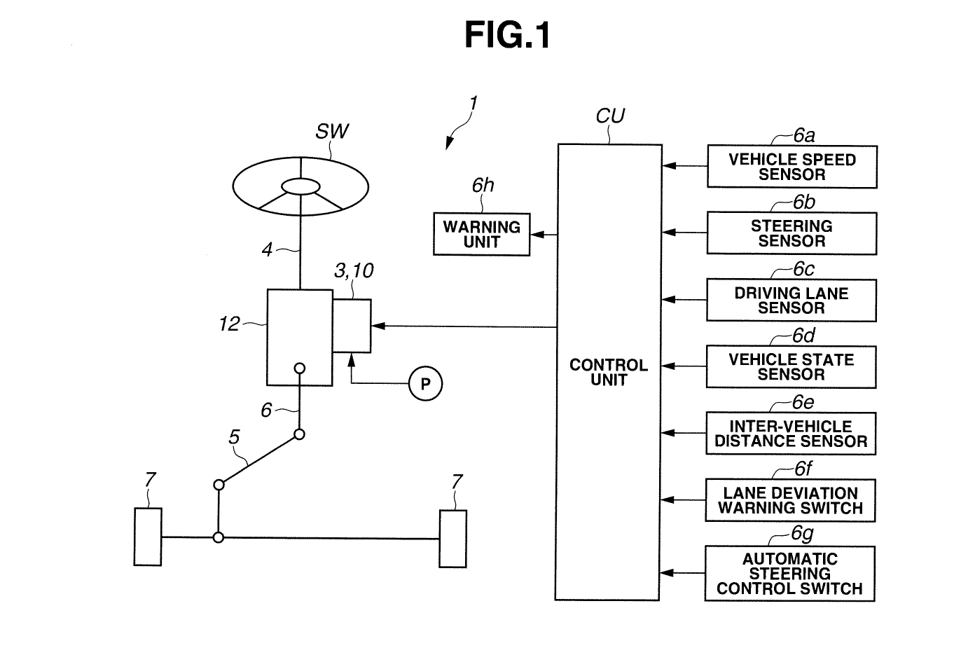

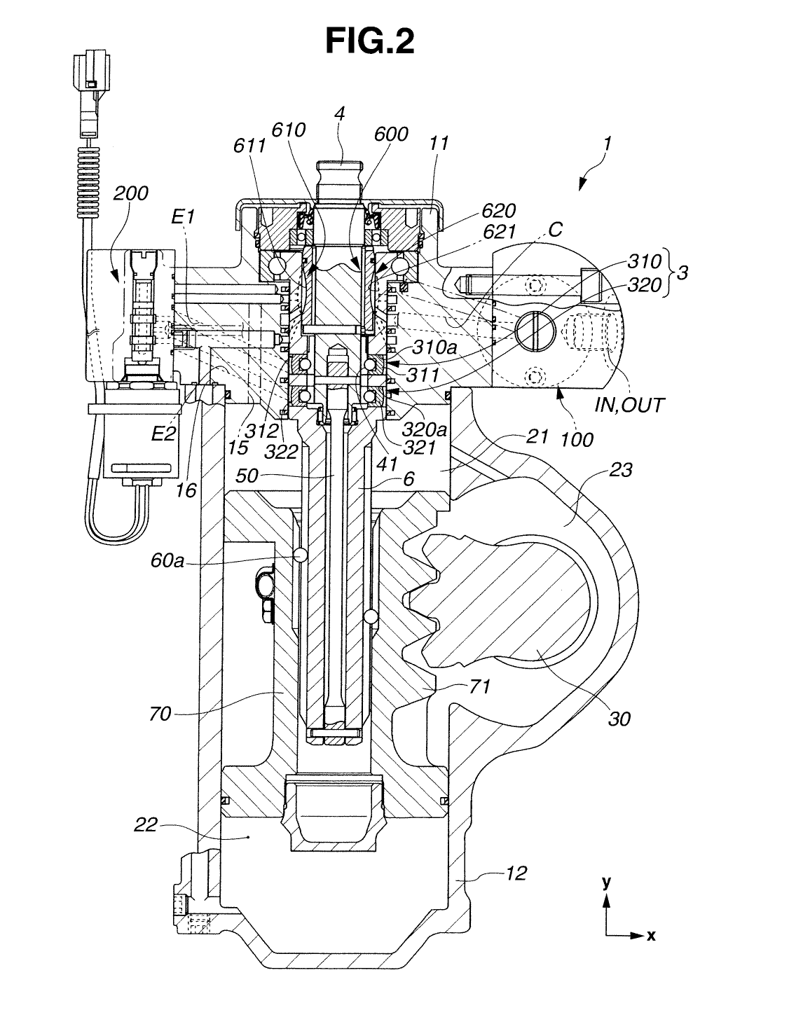

Referring to FIGS. 1 and 2, the first embodiment refers to a power steering apparatus 1 for an automotive vehicle including a steering wheel SW, a steering shaft actuation unit 3, steering input and output shafts 4 and 6, a sector shaft 30, a link mechanism 5, a hydraulic control unit 10, a housing 11, a power cylinder 12, a control valve 600, a hydraulic pump P, an electronic control unit CU and a condition detection unit. It is herein noted that: the terms “clockwise” and “counterclockwise” are used to indicate directions as viewed from a vehicle driver; the terms “right” and “left” are also used instead of “clockwise” and “counterclockwise”, respectively; and the XYZ coordinate system is defined including the x-axis perpendicular to the steering shaft axis (positive in the direction toward the steering input shaft 4), the y-axis parallel to the steering shaft axis (positive in the direction from the power cylinder 12 toward the sector shaft 30) and the z-axis perpendicular to the x axis and y axis to indicate locations in the power steering apparatus 1.

The hydraulic pump P discharges a working fluid to the power cylinder 12.

The power cylinder 12 is substantially in the form of a cup shape (bottomed cylindrical shape) and has a piston 70 axially movably and liquid-tightly disposed therein to divide the inner space of the power cylinder 12 into a first hydraulic chamber 21 on the positive y-axis side and a second hydraulic chamber 22 on the negative y-axis side.

The steering input and output shafts 4 and 6 are coaxially aligned with each other. The steering input shaft 4 has one end connected to the steering wheel SW and the other end overlapped with and connected to the steering output shaft 6 through a torsion bar 50. Further, the steering output shaft 6 is inserted in a center longitudinal bore of the piston 70 and engaged with the piston 70 through a ball screw mechanism 60a.

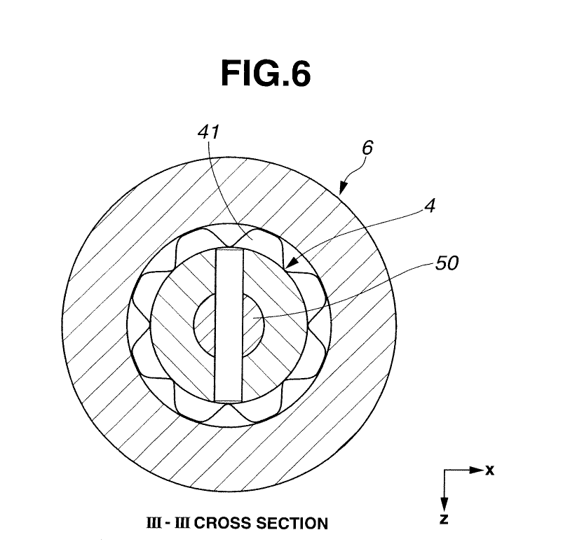

As shown in FIGS. 5 and 6, the overlapped ends of the steering input and output shafts 4 and 6 are formed with serrated sections 41 and 61, respectively. The input shaft serrated section 41 is loosely meshed with the output shaft serrated section 61 in such a manner that crests 44 of the serrated section 41 are restricted within roots 62 of the serrated section 600. This loose meshing allows a given amount of relative rotation between the steering input and output shafts 4 and 6 and prevents an excessive twist of the torsion bar 50.

The sector shaft 30 is aligned normal to the axis of the power cylinder 12, with a part of the sector shaft 30 accommodated in a radial circumferential section (referred to as “sector shaft accommodation section”) 23 of the power cylinder 12, and has a toothed section held in mesh with an outer circumferential toothed section 71 of the piston 70. The sector shaft accommodation section 23 is in communication with the first hydraulic chamber 21 so that the working fluid is fed from the first hydraulic chamber 21 to the sector shaft accommodation section 23 to lubricate the meshing site between the toothed section of the sector shaft 30 and the external tooth section 71 of the piston 70.

The housing 11 is also substantially in the form of a cup shape (bottomed cylindrical shape). The housing 11 and the power cylinder 12 are joined together at open ends thereof to surround therein the steering input and output shafts 4 and 6 with the steering input shaft 4 extending through the bottom of the housing 11. Fluid inlet and outlet ports IN and OUT are formed in the housing 11 for supply and drain of the working fluid.

The control valve 600 is placed in the housing 11 on the positive y-axis side of the overlap area between the steering input and output shafts 4 and 6. As will be described in detail below, the control valve 600 has a rotary valve mechanism to supply and drain the working fluid via the fluid inlet and outlet ports IN and OUT and distribute the hydraulic pressure of the working fluid from the pump P to the first and second hydraulic chambers 21 and 22 selectively according to the rotational direction of the steering input shaft 4 relative to the steering output shaft 6 in response to the steering operation of the steering wheel SW.

The steering shaft actuation unit 3 has a hydraulic actuator mechanism driven by the hydraulic pressure from the pump P to rotate the steering input shaft 4 in either a clockwise or counterclockwise direction.

The hydraulic control unit 10 has a spool valve mechanism to supply the working from the pump P to either of the steering shaft actuation unit 3 and the control valve 600 selectively.

The condition detection unit includes a vehicle speed sensor 6a, a steering sensor (e.g. a steering angle sensor or torque sensor) 6b, a driving lane sensor 6c, a vehicle state sensor (e.g. a yaw rate sensor or lateral acceleration sensor) 6d, an inter-vehicle distance sensor 6e, a lane deviation warning switch 6f and an automatic steering control switch 6g as shown in FIG. 1, so as to detect information about at least one of the conditions of the vehicle, driver and driving road and output signals responsive to the detected information about the vehicle, driver and road conditions.

The control unit CU controls the operations of the hydraulic control unit 10 based on the signal from the condition detection unit, to regulate the supply of the hydraulic pressure to the steering shaft actuation unit 3 and the control valve 600.

In the normal power steering mode, the hydraulic control unit 10 supplies the hydraulic pressure from the pump P to the control valve 600. When the control valve 600 distributes the hydraulic pressure between the hydraulic chambers 21 and 22, the piston 70 moves axially linearly within the power cylinder 12 in response to the hydraulic pressure difference between the hydraulic chambers 21 and 22. The linear movement of the piston 70 is converted into the rotational movement of the sector shaft 30 through the meshing site between the toothed section of the sector shaft 30 and the toothed section 71 of the piston 70. The rotational movement of the sector shaft 30 is then outputted as a steering assist force to rotate and steer vehicle road wheels 7 via the link mechanism 5.

In the automatic steering mode, the hydraulic control unit 10 supplies the hydraulic pressure from the pump P to the steering shaft actuation unit 3 and drives the steering shaft actuation unit 3. The steering shaft actuation unit 3 rotates the steering input shaft 4 and thereby actuates the control valve 600 indirectly for automatic steering control.

Referring again to FIG. 1 the power steering apparatus 1 also includes a warning unit 6h actuated by the control unit CU to give a warning to the driver when the vehicle is judged as being deviated from the current driving lane. The power steering apparatus 1 may alternatively be so structured that the control unit CU causes the hydraulic control unit 10 to drive the steering shaft actuation unit 3 and vibrate the steering wheel SW by alternate clockwise and counterclockwise rotations of the steering input shaft 4 as a warning to the driver.

The configurations of the control valve 600, the steering shaft actuation unit 3 and the hydraulic control unit 10 will be explained below in more detail.

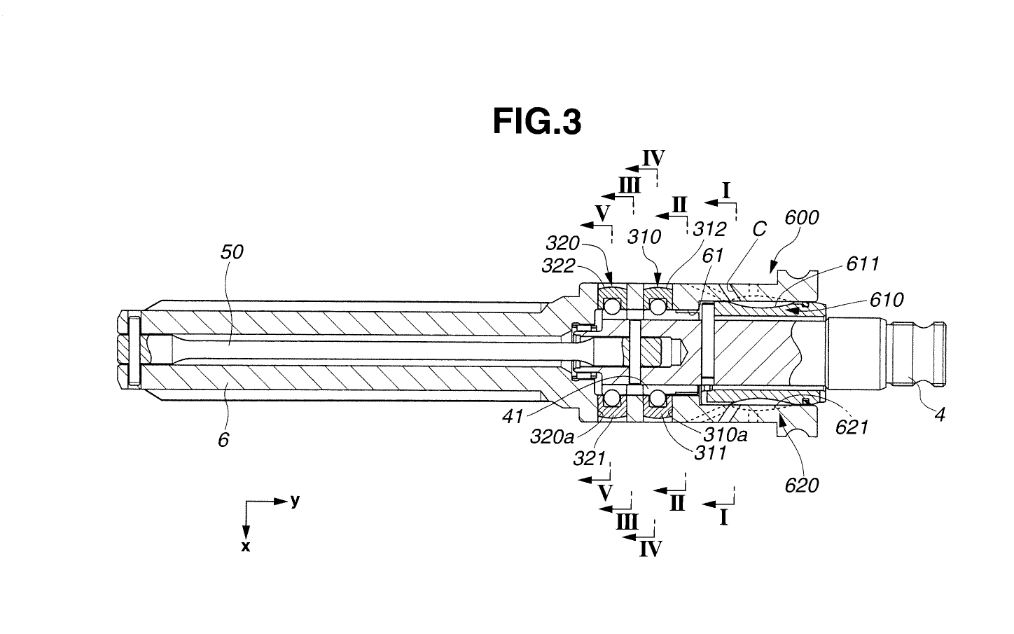

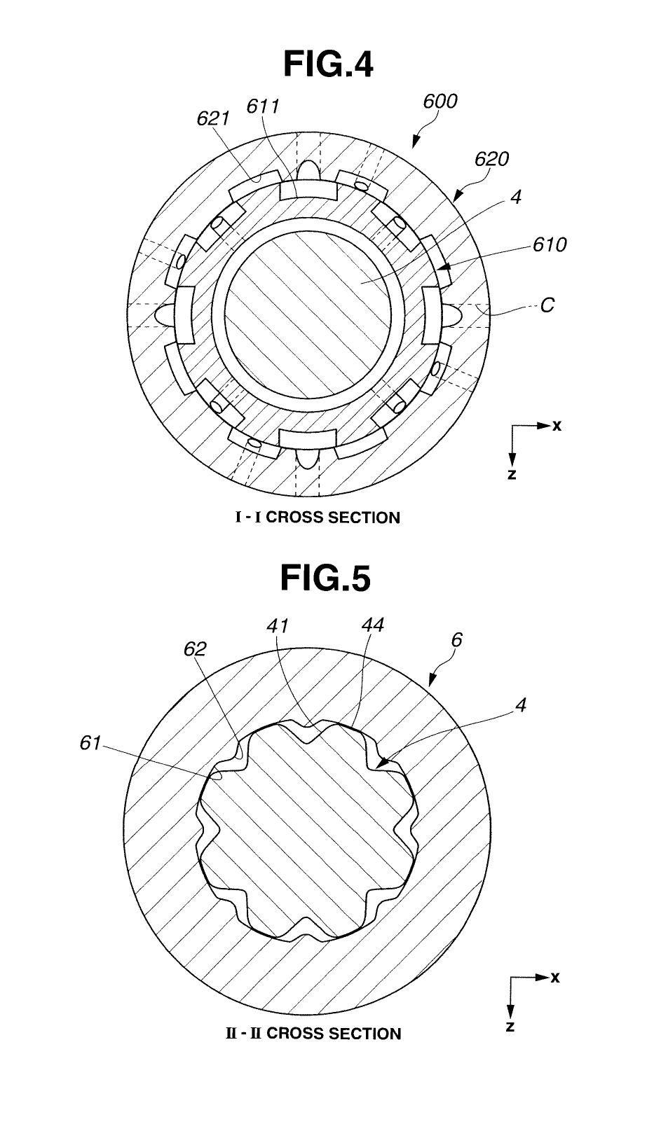

As shown in FIGS. 2 to 4, the control valve 600 includes inner and outer valve members 610 and 620 located in the overlap area between the steering input and output shafts 4 and 6 to control the supply of the hydraulic pressure from the pump P to the first and second hydraulic chambers 21 and 22 and thereby switch the direction of the steering assist torque.

The inner valve member 610 (as a rotator) is formed into a hollow cylindrical shape and disposed around the outer circumferential side of the steering input shaft 4. Valve recesses 611 are cut radially inwardly in the outer circumferential side of the inner valve member 610 and circumferentially equally spaced from each other.

The outer valve member 620 (as a valve body) is formed by cutting valve recesses 621 radially outwardly in the inner circumferential side of the steering output shaft 6 at circumferentially equally spaced positions.

When the steering input shaft 4 is rotated in the clockwise direction relative to the steering output shaft 6, the control valve 600 provides a communication from the pump P to the first hydraulic chamber 21 via a hydraulic passage 15 through the housing 11. The control valve 600 provides a communication from the pump P to the second hydraulic chamber 22 via a hydraulic passage 16 through the housing 11 and the power cylinder 11 when the steering input shaft 4 is rotated in the counterclockwise direction relative to the steering output shaft 6.

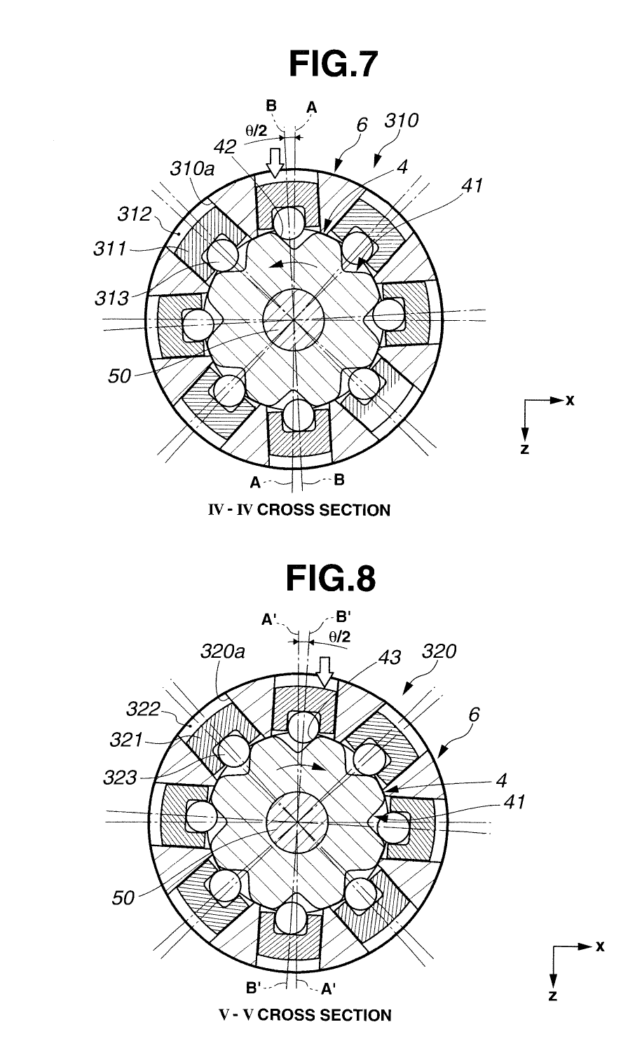

As shown in FIGS. 2, 3, 7 and 8, the steering shaft actuation units 3 includes left and right steering actuators 310 and 320 located in parallel with each other on the negative y-axis side of the control valve 600 in the overlap area between the steering input and output shafts 4 and 6.

The left and light steering actuators 310 and 320 have bores 310a and 320a formed radially outwardly in the steering output shaft 6 and pistons 311 and 321 slidably disposed in the bores 310a and 320a to define hydraulic chambers 312 on the radially outsides of the pistons 311 and 321, respectively. In the first embodiment, eight sets of circumferentially equally spaced bores 310a and pistons 311 and eight sets of circumferentially equally spaced bores 320a and pistons 321 are provided. The pistons 311 and 321 have substantially spherical contact sections 313 and 323 formed at inner radial ends thereof for contact with the serrated section 41 of the steering input shaft 4.

The rotational positions of the left and right steering actuators 310 and 320 are displaced from each other in such a manner that the piston bores 310a and 320a have center axes B-B and B′-B′ form an offset angle θ/2 with respect to lines A-A and A′-A′ connecting two opposite roots (deepest parts) of the input shaft serrated section 41, respectively. Each of the piston contract sections 313 is thus pressed against a first angled contact surface 42 of the input shaft serrated section 41 on the counterclockwise side of the B-B axis relative to the A-A axis so as to apply a torque to the steering input shaft 4 in the counterclockwise direction by the supply of the hydraulic pressure into the hydraulic chamber 312. Each of the piston contact sections 323 is pressed against a second angled contact surface 43 of the input shaft serrated section 41 on the clockwise side of the B′-B′ axis relative to the A′-A′ axis so as to apply a torque to the steering input shaft 4 in the clockwise direction by the supply of the hydraulic pressure into the hydraulic chamber 322.

As shown in FIGS. 2, 9 and 12, the hydraulic control unit 10 includes two electrically-operated spool valves: a pressure regulation valve 100 (first solenoid valve) on the positive x-axis side of the housing 11 and a directional control valve 200 (second solenoid valve) on the negative x-axis side of the housing 11 for simple valve structure and less pressure leakage.

The pressure regulation valve 100 is connected to a discharge side of the pump P via a hydraulic passage B, to the directional control valve 200 via a hydraulic passage A through the housing 11 and to the control valve 600 via a hydraulic passage C through the housing 11, so as to supply the hydraulic pressure from the pump P to the directional control valve 200 and the control valve 600 selectively.

The directional control valve 200 is connected to the hydraulic chambers 312 and 322 of the steering shaft actuation unit 3 via hydraulic passages E1 and E2 through the housing 11, respectively, so as to supply the hydraulic pressure from the pressure regulation valve 100 to the hydraulic chambers 312 and 322 selectively.

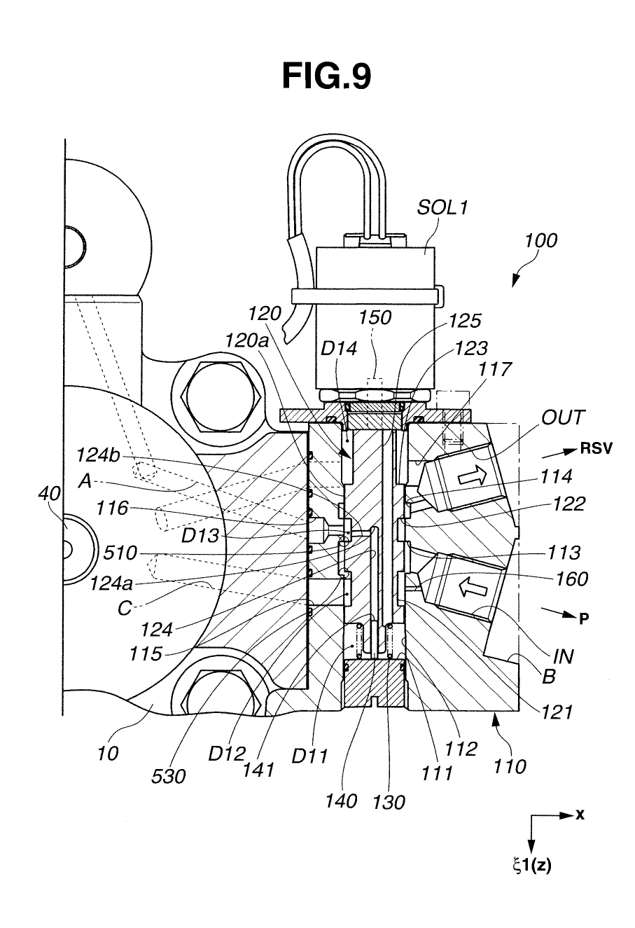

More specifically, the pressure regulation valve 100 has a housing 110, a spool 120, a spring 130, a slide pin 140 and a solenoid SOL1 as shown in FIGS. 9 to 11. The axial direction of the pressure regulation valve 100 is herein defined as the ξ1-axis direction (corresponding to the z-axis direction perpendicular to x- and y-axis directions) where the positive side of the ξ1-axis direction is from the solenoid SOL1 to the spool 120.

The valve housing 110 is formed into a cylindrical shape with a bottom 111 of the housing 110 directed to the positive ξ1-axis side. Two circumferential grooves 113 and 114 are formed in an inner circumferential surface 112 of the valve housing 110. The groove 113 on the positive ξ1-axis side is in communication with the discharge side of the pump P via the hydraulic passage B. The groove 114 on the negative ξ1-axis side is in communication with a fluid reservoir RSV. For simplicity, the grooves 113 and 114 are hereinafter referred to as “pressure introduction groove” and “reservoir communication groove”, respectively. Three radial communications holes 115, 116 and 117 are also formed in the valve housing 110. The communication hole 115 is located on the positive ξ1-axis side of the pressure introduction groove 113 and has one end opened to the inner circumferential surface 112 of the valve housing 110 and the other end communicating with the control valve 600 via the hydraulic passage C. The communication hole 117 is located on the negative ξ1-axis side of the reservoir communication groove 114 and has one end opened to the inner circumferential surface 112 of the valve housing 110 and the other end communicating with the fluid reservoir RSV. The communication hole 116 is located between the pressure introduction groove 113 and the reservoir communication groove 114 and has one end opened to the inner circumferential surface 112 of the valve housing 110 and the other end communicating with the directional control valve 200 via the hydraulic passage A. The communication holes 115, 116 and 117 are hereinafter referred to as “control valve communication hole”, “spool communication hole” and “reservoir communication hole”, respectively.

The spool 120 is formed into a substantially cylindrical shape and axially slidably inserted in the valve housing 110 with an outer circumferential surface 120a of the spool 120 held in liquid-tight sliding contact with the inner circumferential surface 112 of the valve housing 110. There is a first hydraulic chamber D11 defined between the bottom 111 of the valve housing 110 and the positive ξ1-axis end of the spool 120. Two grooves 121 and 122 are formed radially inwardly and circumferentially in the outer circumferential surface 120a of the spool 120 to define second and third hydraulic chambers D12 and D13 between the outer circumferential surface 120a of the spool 120 and the inner circumferential surface 112 of the valve housing 110, respectively. In the first embodiment, the circumferential grooves 121 and 122 are formed at positions that the second and third hydraulic chambers D12 and D13 are always in communication with the control valve communication hole 115 and the spool communication hole 116, respectively. The spool 120 also has a cut 123, a pin hole 124 and a through hole 125. The cut 123 is formed by cutting away the negative ξ1-axis end of the spool 120 radially inwardly and circumferentially to define a fourth hydraulic chamber D14 between the outer circumferential surface 120a of the spool 120 and the inner circumferential surface 112 of the valve housing 110. The fourth hydraulic chamber D14 (cut 123) is always in communication with the reservoir communication hole 117 to develop a drain pressure. The through hole 125 is formed through the spool 120 in the ξ1-axis direction so as to provide a communication between the first and fourth hydraulic chambers D11 and D14. As the drain pressure is constantly fed from the fourth hydraulic chamber D14 to the first hydraulic chamber D11 via the through hole 125, the first and fourth hydraulic chambers D11 and D14 are always kept equal in pressure. The first to fourth hydraulic chambers D11, D12, D13 and D14 are thus liquid-tightly confined in order of mention from the positive ξ1-axis side. The pin hole 124 is coaxially formed in the positive ξ1-axis end of the spool 120 and is in communication with the third hydraulic chamber D13 (groove 122) via a radial bore 124b.

Further, a throttle hole 160 is formed in the valve housing 110 to establish a communication passage from the discharge side of the pump P to the inner circumferential surface 112 of the valve housing 110 without passing through the pressure introduction groove 113 as shown in FIG. 9. The opening of the throttle hole 160 corresponds in position in the ξ1-axis direction to the control valve communication hole 115 so that the throttle hole 160 is always in communication with the second hydraulic chamber D12 (groove 121) irrespective of the operation position of the spool 120. The minimum required pump discharge pressure for automatic steering control is thus fed from the throttle hole 160 to the control valve communication hole 115 via the second hydraulic chamber D12 (groove 121) and supplied to the control valve 600 so as to produce a minimum steering assist irrespective of the operation state of the pressure regulation valve 100.

The spring 130 is disposed in the first hydraulic chamber D11 so as to bias the spool 120 in the negative ξ1-axis direction.

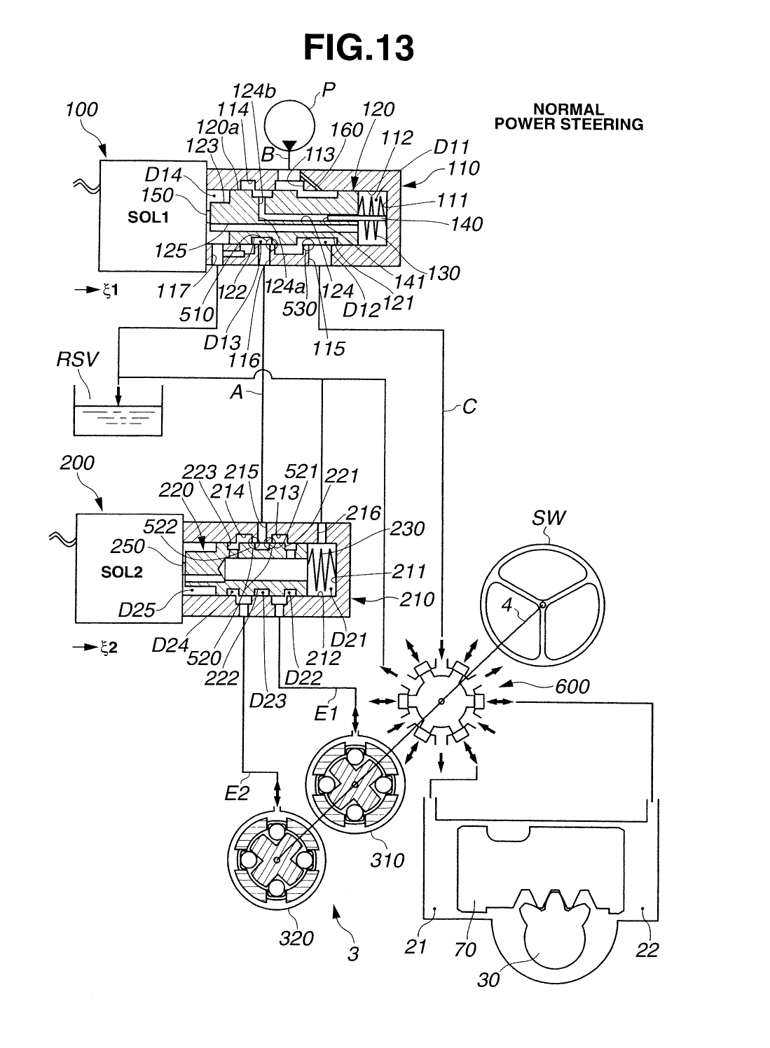

The solenoid SOL1 is connected to the spool 120 via a shaft member 150 so as to move the spool 120 in the ξ1-axis direction against or under the biasing force of the spring 130 through the energization control of the solenoid SOL1 (see also FIG. 13).

When the spool 120 is moved in the negative ξ1-axis direction, the second hydraulic chamber D12 (groove 121) is brought into communication with the pressure introduction groove 113 so as to provide a hydraulic passage from the pressure introduction groove 113 to the control valve communication hole 115 via the second hydraulic chamber D12. The hydraulic passage from the pressure introduction groove 113 to the control valve communication hole 115 via the second hydraulic chamber D12 is herein defined as a steering assist pressure introduction passage 530. With this, the pressure regulation valve 100 establishes a communication between the pump P and the control valve 600 through the steering assist pressure introduction passage 530 and the hydraulic passages B and C, thereby supplying the discharge pressure of the pump P to the control valve 600. The opening cross-sectional area of the steering assist pressure introduction passage 530 is changed by the axial movement of the spool 120, so as to regulate the pump discharge pressure due to its orifice effect. The regulated pump discharge pressure is fed as a steering assist pressure to the control valve 600. On the other hand, the third hydraulic chamber D13 (groove 122) is cut off from the pressure introduction hole 113 and brought into communication with the reservoir communication hole 114 so as to establish a hydraulic passage from the reservoir communication hole 114 to the spool communication hole 116 via the third hydraulic chamber D13. The drain pressure is then fed from the pressure regulation valve 100 to the directional control valve 200 through the hydraulic passage A.

When the spool 120 is moved in the positive ξ1-axis direction, the assist pressure introduction passage 530 is narrowed down to reduce the flow of the working fluid from the pump P to the control valve 600 and thereby increase the pump discharge pressure. On the other hand, the third hydraulic chamber D13 (groove 122) is brought into communication with the pressure introduction groove 113 so as to provide a hydraulic passage from the pressure introduction groove 113 to the spool communication hole 116 via the third hydraulic chamber D13. The hydraulic passage from the pressure introduction groove 113 to the spool communication hole 116 via the third hydraulic chamber D13 is herein defined as an actuator control pressure introduction passage 510. With this, the pressure regulation valve 100 establishes a communication between the pump P and the directional control valve 200 through the actuator control pressure introduction passage 510 and the hydraulic passages A and B, thereby supplying the pump discharge pressure to the directional control valve 200. The opening cross-sectional area of the actuator control pressure introduction passage 510 is changed by the axial movement of the spool 120, so as to regulate the pump discharge pressure due to its orifice effect. The regulated pump discharge pressure is fed as a control pressure to the directional control valve 200. The control pressure is also fed to the pin hole 124 via the radial bore 124b.

In this way, the pressure regulation valve 100 regulates the supply of the hydraulic pressure from the pump P to the control valve 600 and the directional control valve 200 and varies the steering assist pressure and the actuator control pressure along with the operational position of the spool 120 through the energization control of the solenoid SOL1. In particular, the pressure regulation valve 100 is so structured as to increase the pump discharge pressure supplied to the steering shaft actuation unit 3 only when the automatic steering control is demanded. It is thus possible to reduce pumping loss and prevent fuel efficiency deterioration and fluid temperature rise.

The pin 140 is slidably inserted in the positive ξ1-axis side of the pin hole 124 and has a bearing surface 141 opposing a bearing surface 124a of the pin hole 124. In the first embodiment, the bearing surfaces 124a and 141 are equal in area. With the supply of the control pressure from the third hydraulic chamber D13 to the pin hole 124 via the radial bore 124b, the bearing surfaces 141 and 124a receive hydraulic forces in the positive and negative ξ1-axis directions, respectively. In the case of τ≧F where is the sliding resistance (unit: N) between the slide pin 140 and the pin hole 124 and F is the hydraulic force (unit: N) exerted on the bearing surface 141, 124a under the hydraulic pressure in the pin hole 140, the hydraulic force F on the bearing surface 141 is absorbed by the sliding resistance τ between the slide pin 140 and the pin hole 124 and acts on the spool 120 in the positive ξ1-axis direction so as to balance with the hydraulic force F on the bearing surface 124a. In the case of τ<F, the hydraulic force F on the bearing surface 141 is not absorbed by the sliding resistance τ between the slide pin 140 and the pin hole 124 and does not act on the spool 120 in the positive ξ1-axis direction. The hydraulic force F on the bearing surface 124a is unbalanced and acts on the spool 120 so that the spool 120 makes a sliding movement in the negative ξ1-axis direction relative to the slide pin 140. Namely, the spool 120 moves in the negative ξ1-axis direction relative to the slide pin 140 when the control pressure supplied to the pin hole 124 increases to satisfy the relationship of τ<F. By the movement of the spool 120 in the negative ξ1-axis direction, the third hydraulic chamber D13 is cut off from the pressure introduction groove 113 to stop the supply of the control pressure from the hydraulic chamber D13 to the pin hole 124 and is then brought into communication with the reservoir communication groove 114 to feed the drain pressure to the pin hole 124.

In the presence of no slide pin 140 and no pin hole 124, the control pressure is relieved only by the hydraulic chamber D13 and the hydraulic passage A during the movement of the spool 120 in the positive ξ1-axis direction and thus increases significantly with the pump discharge pressure.

However, it suffices to introduce the actuator control pressure to the directional regulation valve 200 and then to the steering actuator 310, 320 so that the steering actuator 310, 320 can generate a torque to rotate the steering input shaft 4 and thereby cause the control valve 600 to supply the hydraulic pressure to the hydraulic chambers 21 and 22 for automatic steering control without the driver's steering operation. There is no need for the steering actuator 310, 320 to generate a large torque that rotates the steering input shaft 4 through a large angle and, by extension, no need for the pressure regulation valve 100 to increase the actuator control pressure excessively.

In the presence of the slide pin 140 and the pin hole 124, by contrast, it is possible to provide a relief for the actuator control pressure as mentioned above and thereby possible to prevent an excessive increase in the actuator control pressure.

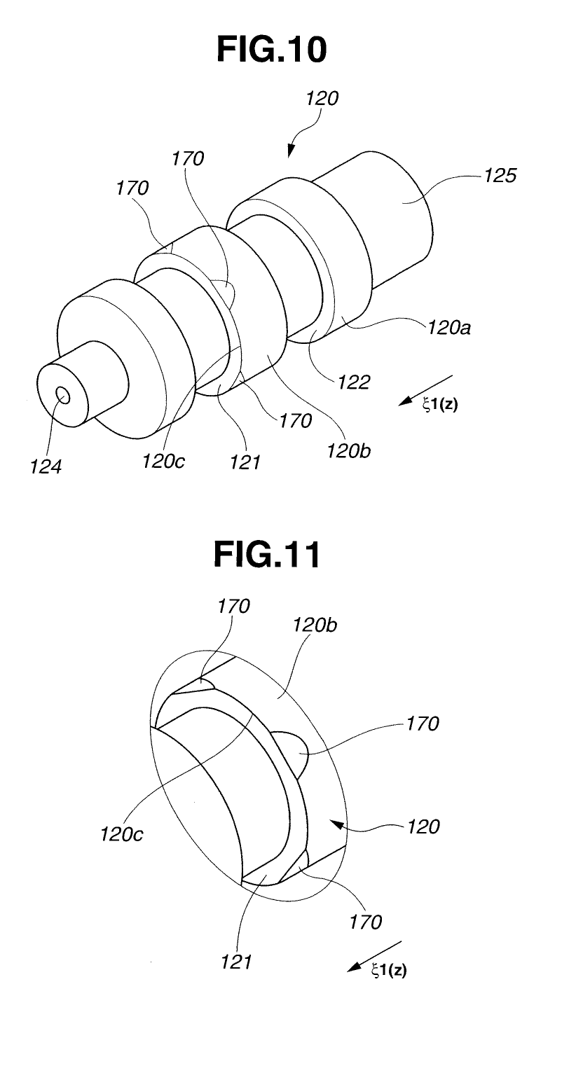

Furthermore, the outer circumferential surface 120a of the spool 120 includes a land 120b located between the grooves 121 and 122 to define a step 120c with a chamfered section on the positive ξ1-axis end of the land 120b, i.e., on the negative ξ1-axis side of the groove 121 as shown in FIGS. 10 and 11. In the first embodiment, the chamfered section includes circumferentially equally spaced chamfers 170 each having a flat tapered chamfer surface.

In the presence of no chamfers 170, the steering assist pressure introduction passage 530 (notably, the communication channel between the second hydraulic chamber D12 and the pressure introduction groove 113) becomes opened and closed abruptly to cause a sudden change in the flow of the working fluid.

In the presence of the chamfers 170, by contrast, the assist pressure introduction passage 530 becomes gradually opened and closed to relieve a sudden change in the flow of the working fluid and thereby introduce the pump discharge pressure smoothly. It is thus possible to regulate the actuator control pressure smoothly.

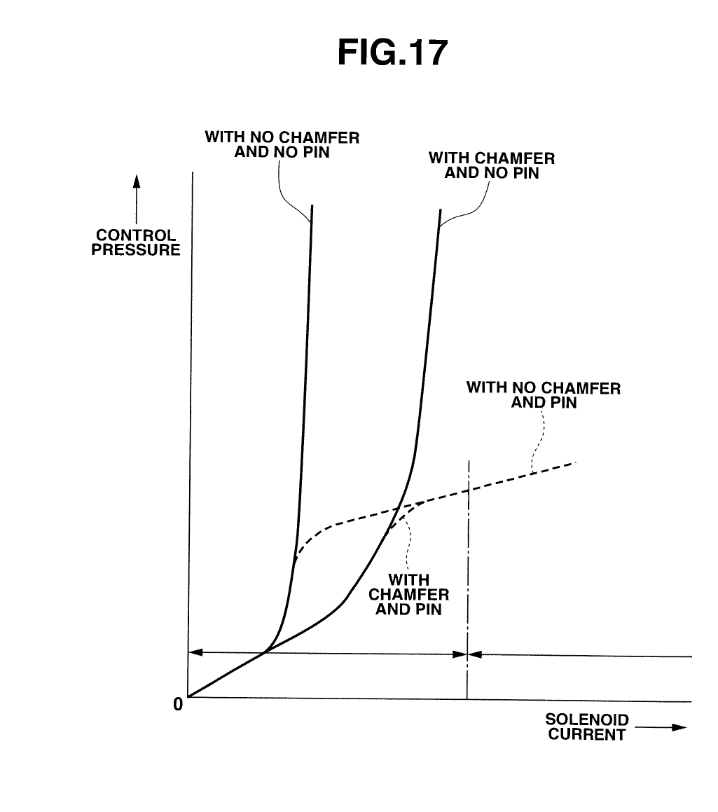

The pressure regulation characteristics of the pressure regulation valve 100 are summarized in FIG. 17. The actuator control pressure significantly increases with the pump discharge pressure in the presence of no slide pin 140 but can be prevented from excessive increase in the presence of the slide pin 140. The actuator control pressure increases significantly with the current to the solenoid SOL1 (i.e. the movement of the spool 120) in the presence of no chamfers 170 but can be controlled gradually in the presence of the chamfers 170. As shown in FIG. 17, the combined application of the slide pin 140 and the chamfers 170 allows the control pressure to be controlled linearly with respect to the solenoid current for improvement in controllability.

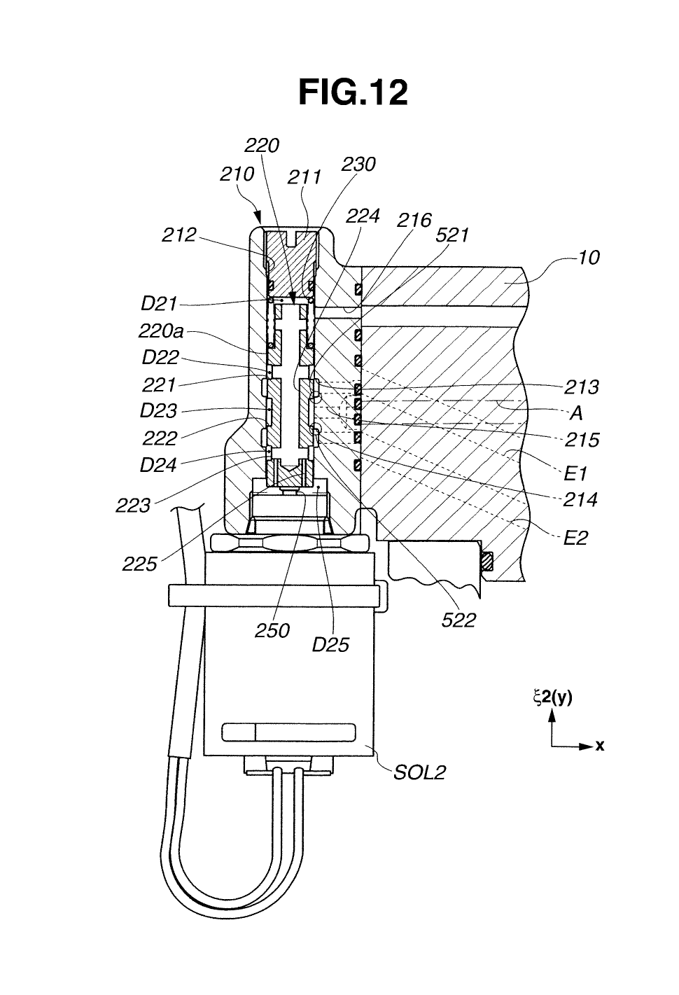

As shown in FIG. 12, the directional control valve 200 includes a housing 210, a spool 220, a spring 230 and a solenoid SOL2. The axial direction of the directional control valve 200 is herein defined as the ξ2-axis direction (parallel to the y-axis direction) where the positive side of the ξ2-axis direction is from the solenoid SOL2 to the spool 220.

The valve housing 210 is formed into a cylindrical shape with a bottom 211 of the housing 210 directed to the positive ξ2-axis side. Two circumferential grooves 213 and 214 are formed in an inner circumferential surface 212 of the valve housing 210. The groove 213 on the positive ξ2-axis side is in communication with the left steering actuator 310 via the hydraulic passage E1. The groove 214 on the negative ξ2-axis side is in communication with the right steering actuator 320 via the hydraulic passage E2. For simplicity, the grooves 213 and 214 are hereinafter referred to as “left and right steering actuator communication grooves”, respectively Further, two radial communication holes 215 and 216 are formed in the valve housing 210. The communication hole 215 is located between the left and right steering actuator communication grooves 213 and 214 and has one end opened to the inner circumferential surface 212 of the valve housing 210 and the other end communicating with the hydraulic passage A. The communication hole 216 is located on the positive ξ2-axis side of the left steering actuator communication groove 213 and communicating with the fluid reservoir RSV. The communication holes 215 and 216 are hereinafter referred to as “spool communication hole” and “reservoir communication hole”, respectively.

The spool 220 is formed into a substantially cylindrical shape and axially slidably inserted in the valve housing 210 with an outer circumferential surface 220a of the spool 220 held in liquid-tight sliding contact with the inner circumferential surface 212 of the valve housing 210. There are a first hydraulic chamber D21 defined between the bottom 211 of the valve housing 210 and the positive ξ2-axis end of the spool 220 and a fifth hydraulic chamber D25 defined on the negative ξ2-axis side of the spool 220. Three grooves 221, 222 and 223 are formed radially inwardly and circumferentially in the outer circumferential surface 220a of the spool 220 so as to define second to fourth hydraulic chambers D22, D23 and D24 between the outer circumferential surface 220a of the spool 220 and the inner circumferential surface 212 of the valve housing 210. The first to fifth hydraulic chambers D21 to D25 are thus liquid-tightly confined in order of mention from the positive ξ2-axis side The spool 220 also has two connection holes 224 and 225. The connection hole 224 is coaxially formed in the positive ξ2-axis end of the spool 220 and is in communication with the second and fourth hydraulic chambers D22 and D24 (grooves 221 and 223) but not in communication with the third hydraulic chamber D23 (groove 222). The connection hole 225 is formed in the negative ξ2-axis end of the spool 220 in such a manner that the axis of the hole 225 is displaced from the axis of the spool 220 and is in communication with the connection hole 224. Thus, the first, second, fourth and fifth hydraulic chambers D21, D22, D24 and D25 are communicated with one another via the connection holes 224 and 225. Further, the second hydraulic chamber D22 (groove 221) is brought into communication with the reservoir communication groove 216 upon contact of the spool 220 with the valve housing bottom 211. When the spool 220 is not in contact with the valve housing bottom 221, the first hydraulic chamber D21 is in communication with the reservoir communication groove 216. The drain pressure is thus constantly fed to the hydraulic chamber D21, D22 via the reservoir communication hole 216 so that the first, second, fourth and fifth hydraulic chambers D21, D22, D24 and D25 are always controlled to the drain pressure.

The valve spring 230 is disposed in the first hydraulic chamber D21 so as to bias the spool 220 in the negative ξ2-axis direction.

The solenoid SOL2 is connected to the negative ξ2-axis end of the spool 220 via a shaft member 250 so as to move the spool 220 in the ξ2-axis direction against or under the biasing force of the spring 230 through the energization control of the solenoid SOL2.

Herein, the directional control valve 200 has three operation positions: a reference position and right and left automatic steering positions.

When the spool 220 is set to the reference position, the third hydraulic chamber D23 (groove 222) is cut off from the left and right steering actuator communication grooves 213 and 214. Instead, the second and fourth hydraulic chambers D22 and D24 (grooves 221 and 223) are brought into communication with the first and second communication grooves 213 and 214, respectively, to establish a communication from the left and right steering actuators 310 and 320 to the fluid reservoir RSV through the first and second communication grooves 213 and 214, the first, second and fourth hydraulic chambers D21, D22 and D24 and the connection hole 224. The drain pressure is then fed to the left and right steering actuators 310 and 320 via the hydraulic passages E1 and E2 so that the steering actuators 310 and 320 are not driven and outputs no rotation to the steering input shaft 4.

When the spool 220 is moved in the negative ξ2-axis direction and set to the right steering position, the third hydraulic chamber D23 (groove 222) is brought into communication with the right steering actuator communication groove 214 so as to provide a hydraulic passage from the spool communication hole 215 to the right steering actuator communication groove 214 via the third hydraulic chamber D23. The hydraulic passage from the spool communication hole 215 to the right steering actuator communication groove 214 via the third hydraulic chamber D23 is herein defined as a drive pressure introduction passage 522. With this, the directional control valve 200 establishes a communication to the right steering actuator 320 through the drive pressure introduction passage 522 and the hydraulic passage E2, thereby allowing the supply of the hydraulic pressure from the pressure regulation valve 100 to the right steering actuator 320. The opening cross-sectional area of the drive pressure introduction passage 522 is changed by the axial movement of the spool 220, so as to regulate the supply of the hydraulic pressure from the pressure regulation valve 100 to the right steering actuator 320 due to its orifice effect. In the case of the actuator control pressure (pump discharge pressure) being supplied from the pressure regulation valve 100 through the hydraulic passage A, the actuator control pressure is regulated to a drive pressure and fed to the right steering actuator 320 through the hydraulic passage E2. The right steering actuator 320 is then driven to output a clockwise rotation to the steering input shaft 4. The right steering actuator 320 is not driven in the case of the drain pressure being supplied from the pressure regulation valve 100 through the hydraulic passage A. On the other hand, the second hydraulic chamber D22 (groove 221) is in communication with the left steering actuator communication groove 213 irrespective of the negative ξ2-axis movement of the spool 220. The drain pressure is fed to the left steering actuator 310 through the hydraulic passage E1 so that the left steering actuator 310 is not driven and outputs no rotation to the steering input shaft 4.

When the spool 220 is moved in the positive ξ2-axis direction and set to the left steering position, the third hydraulic chamber D23 (groove 222) is brought into communication with the left steering actuator communication groove 213 so as to provide a hydraulic passage from the spool communication hole 215 to the left steering actuator communication groove 213 via the third hydraulic chamber 23 The hydraulic passage from the spool communication hole 215 to the left steering actuator communication groove 213 via the third hydraulic chamber 23 is herein defined as a drive pressure introduction passage 521. With this, the directional control valve 200 establishes a communication to the left steering actuator 310 through the drive pressure introduction passage 521 and the hydraulic passage E1, thereby allowing the supply of the hydraulic pressure from the directional control valve 200 to the left steering actuator 310. The opening cross-sectional area of the drive pressure introduction passage 521 is changed by the axial movement of the spool 220, so as to regulate the supply of the hydraulic pressure from the pressure regulation valve 100 to the left steering actuator 310 due to its orifice effect. In the case of the actuator control pressure (pump discharge pressure) being supplied from the pressure regulation valve 100 through the hydraulic passage A, the actuator control pressure is regulated to a drive pressure and fed to the left steering actuator 310 through the hydraulic passage E1. The left steering actuator 310 is then driven to output a counterclockwise rotation to the steering input shaft 4. The left steering actuator 310 is not driven in the case of the drain pressure being supplied from the pressure regulation valve 100 through the hydraulic passage A. On the other hand, the fourth hydraulic chamber D24 (groove 223) is brought into communication with the right steering actuator communication groove 214 irrespective of the positive ξ2-axis movement of the spool 220. The drain pressure is fed to the right steering actuator 320 through the hydraulic passage E2 so that the right steering actuator 320 is not driven and outputs no rotation to the steering input shaft 4.

In this way, the directional control valve 200 regulates the supply of the hydraulic pressure to the left and right steering actuators 310 and 320 and varies the actuator drive pressures along with the operational position of the spool 220 through the energization control of the solenoid SOL2. By regulating the supply of the hydraulic pressure to the left and right steering actuators 310 and 320 with the use of a single directional control valve 200, it is possible to avoid pressure control fluctuations that can be caused due to variations between individual control valves. It is also possible to simplify the structure of the directional control valve 200 for cost reduction as the directional control valve 200 has only three operating positions.

The overall operations of the power steering apparatus 1 will be explained below.

### [Straight Driving and Normal Power Steering Mode]

In the straight driving and in the normal power steering mode, the spool 120 of the pressure regulation valve 100 is moved to the negative ξ1-axis direction so as to provide a communication between the pump P and the control valve 600 and supply the hydraulic pressure from the pump P to the control valve 600 as shown in FIG. 13. When the steering input shaft 4 is turned right by the driver's steering operation, the control valve 600 communicates with the second hydraulic chamber 22 and supplies the hydraulic pressure to the hydraulic chamber 22 so as to produce a right steering assist force. When the steering input shaft 4 is turned left by the driver's steering operation, the control valve 600 communicates with the first hydraulic chamber 21 and supplies the hydraulic pressure to the first hydraulic chamber 21 so as to generate a left steering assist force. Further, the spool 220 of the directional control valve 200 is set to the reference position so as to cut off the steering actuators 310 and 320 from the pump P and bring the steering actuators 310 and 320 into communication with the fluid reservoir RSV as shown in FIG. 13. The steering actuators 310 and 320 are thus controlled to the drain pressure so as to apply no steering reaction force to the steering input shaft 4.

### [Right Turn in Automatic Steering Mode]

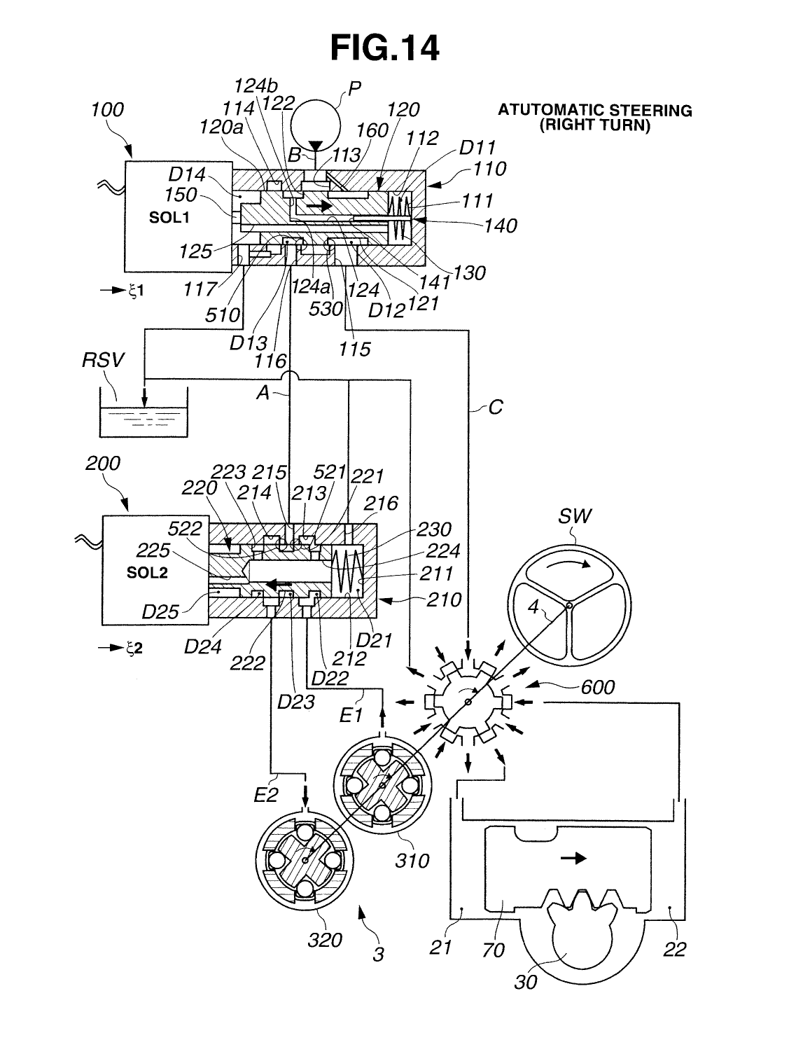

To make a right turn in the automatic steering mode, the spool 120 of the pressure regulation valve 100 is moved in the positive ξ1-axis direction so as to provide a communication between the pump P and the directional control valve 200 and supply the hydraulic pressure from the pump P to the directional control valve 200 as shown in FIG. 14. Further, the spool 220 of the directional control valve 200 is moved in the negative ξ2-axis direction and set to the right automatic steering position so as to provide a communication between the directional control valve 200 and the right steering actuator 320 and a communication between the fluid reservoir RSV and the left steering actuator 310 as shown in FIG. 14. The directional control valve 200 supplies the hydraulic pressure to the right steering actuator 320 so that the right steering actuator 320 is driven to rotate the steering input shaft 4 in the clockwise rotation. As the discharge side of the pump P is in communication with the control valve 600 through the throttle hole 160, the minimum pump discharge pressure required for automatic steering control is supplied from the pump P to the control valve 600 simultaneously with the supply of the hydraulic pressure from the pump P to the right steering actuator 320. The directional control valve 200 also supplies the drain pressure to the left steering actuator 310 so as not to drive the steering actuator 310. Upon the clockwise rotation of the steering input shaft 4, the control valve 600 becomes actuated to supply the hydraulic pressure to the second hydraulic chamber 22 of the power cylinder 12 and produce a right steering force for automatic steering control.

### [Left Turn in Automatic Steering Mode]

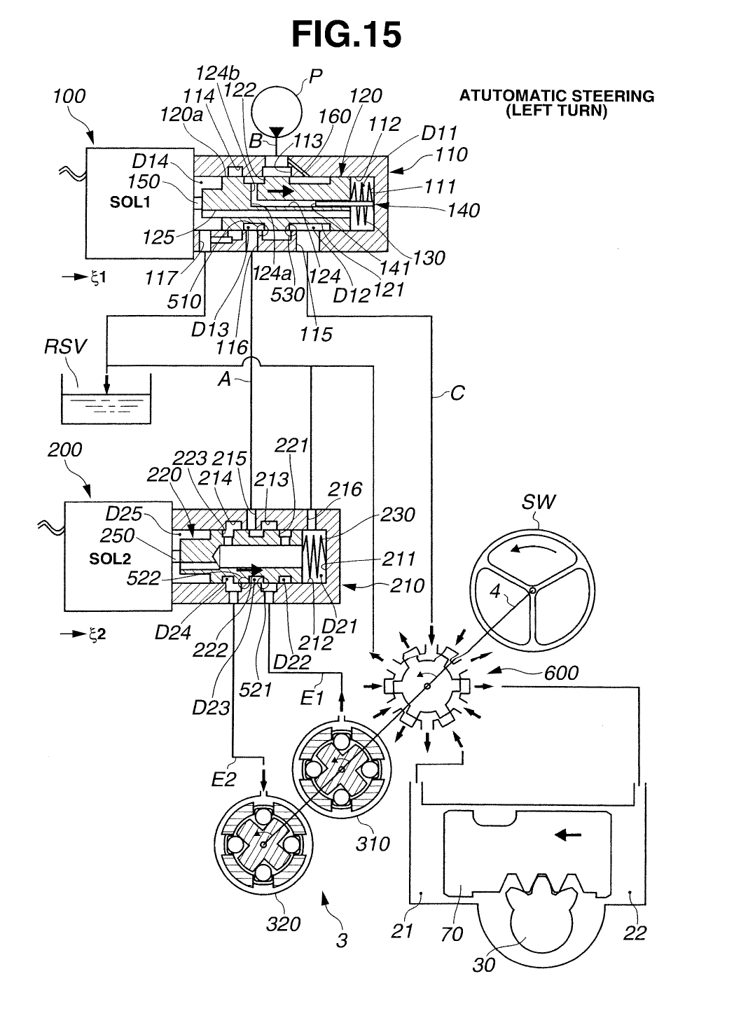

To make a left turn in the automatic steering mode, the spool 120 of the pressure regulation valve is moved in the positive ξ1-axis direction so as to provide a communication between the pump P and the directional control valve 200 and supply the hydraulic pressure from the pump P to the directional control valve 200 as shown in FIG. 15. Further, the spool 220 of the directional control valve 200 is moved in the positive ξ2-axis direction and set to the left automatic steering position so as to provide a communication between the directional control valve 200 and the left steering actuator 310 and a communication between the fluid reservoir RSV and the right steering actuator 320 as shown in FIG. 15. The directional control valve 200 supplies the hydraulic pressure to the left steering actuator 310 so that the steering actuator 310 is driven to rotate the steering input shaft 4 in the counterclockwise direction. As the discharge side of the pump P is in communication with the control valve 600 through the throttle hole 160, the minimum pump discharge pressure required for automatic steering control is supplied from the pump P to the control valve 600 simultaneously with the supply of the hydraulic pressure from the pump P to the left steering actuator 310. The directional control valve 200 also supplies the drain pressure to the right steering actuator 320 so as not to drive the steering actuator 320. Upon the counterclockwise rotation of the steering input shaft 4, the control valve 600 becomes actuated to supply the hydraulic pressure to the first hydraulic chamber 21 of the power cylinder 12 and produce a left steering force for automatic steering, control.

### [Electric System Failure]

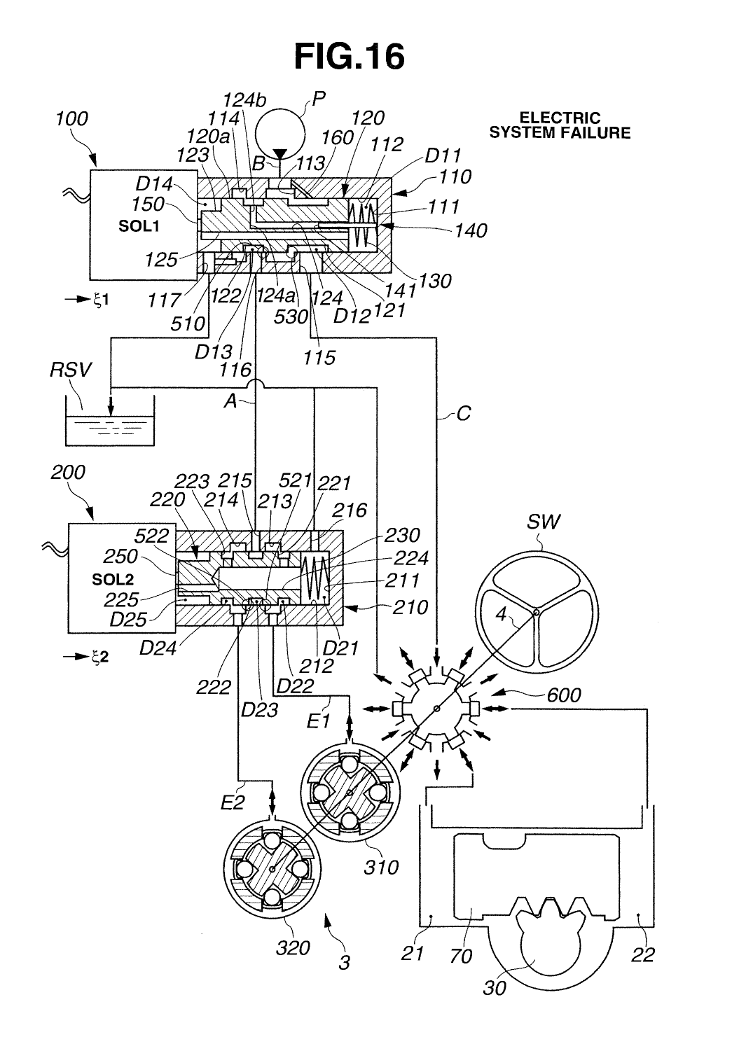

In the event of a failure in either of the solenoids SOL1 and SOL2, the solenoids SOL1 and SOL2 are de-energized. Then, the spool 120 of the pressure regulation valve 100 is moved in the negative ξ1-axis direction under the biasing, force of the spring 130 so as to provide a communication between the pump P and the control valve 600 and a communication between the fluid reservoir RSV and the directional control valve 200 as shown in FIG. 16. The control valve 600 supplies the hydraulic pressure from the pump P to the power cylinder 12 to continue the steering assist, whereas the directional control valve 200 supplies the drain pressure to the steering actuators 310 and 320 to stop the steering shaft actuation unit 3 and thereby terminate the automatic steering control.

As described above, the power steering apparatus 1 is switched among the normal power steering mode, automatic steering mode and fail-safe mode (electric failure mode) depending on the operational positions of the spools 120 and 220 of the pressure regulation valve 100 and the directional control valve 200. The use of the spool valves 100 and 200 enables easy individual control of the opening cross-sectional areas of the pressure introduction passages 510, 521, 522 and 530 and, by extension, easy control of the hydraulic pressure supply. The hydraulic control unit 10 supplies the hydraulic pressure to the steering shaft actuation unit 3 (steering actuator 310, 320) only when the automatic steering control is demanded. At the supply of the hydraulic pressure to the steering shaft actuation unit 3, the hydraulic control unit 10 narrows down the assist pressure introduction passage 530 in such a manner that the opening cross-sectional area of the hydraulic passage 510, 521, 522 for communication to the steering shaft actuation unit 30 is made larger than the opening cross-sectional area of the hydraulic passage 530 for communication to the control valve 600 and thereby increases the hydraulic pressure discharged from the pump to be supplied to the steering shaft actuation unit 3. The hydraulic control unit 10 stops the supply of the hydraulic pressure to the steering shaft actuation unit 3 (steering actuator 310, 320) when the automatic steering control is not demanded. It is therefore possible for the power steering apparatus 1 to reduce pumping loss and prevent fuel efficiency deterioration and fluid temperature rise.

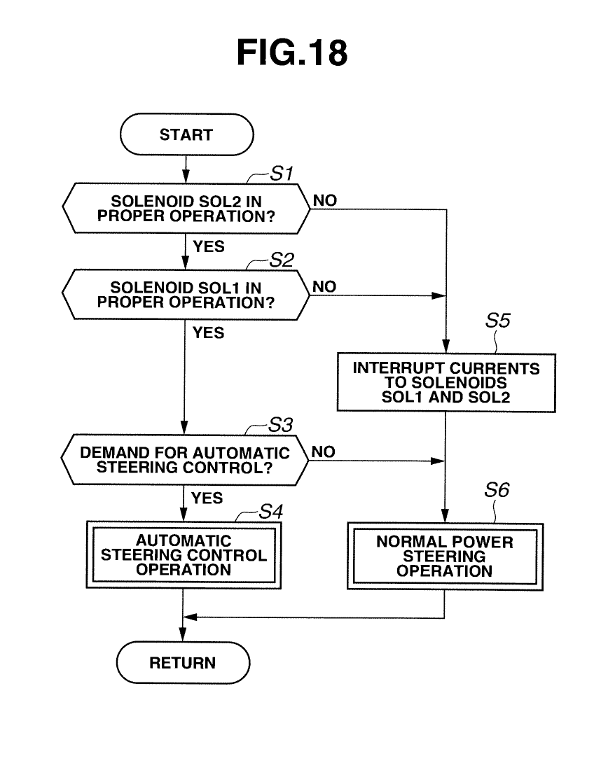

In the first embodiment, the operations of the power steering apparatus 1 are controlled by the control unit CU through a main control program of FIG. 18.

At step S1, the control unit CU judges whether the solenoid SOL2 of the directional control valve 200 functions normally. If YES at step S1, the program proceeds to step S2. If No at step S1, the program proceeds to step S5.

At step S2, the control unit CU judges whether the solenoid SOL1 of the pressure regulation valve 100 functions normally. If YES at step S2, the program proceeds to step S3. If No at step S2, the program proceeds to step S5.

At step S3, the control unit CU judges whether the automatic steering control is demanded. If YES at step S3, the program proceeds to step S4. If No at step S3, the program proceeds to step S6.

At step S4, the control unit CU runs automatic steering control operation by regulating the currents to the solenoids SOL1 and SOL2 (corresponding to the automatic steering mode).

At step S5, the control unit CU interrupts the currents to the solenoids SOL1 and SOL2. The program then proceeds to step S6.

At step S6, the control unit CU runs normal power steering operation (corresponding to the normal steering mode or electric failure mode).

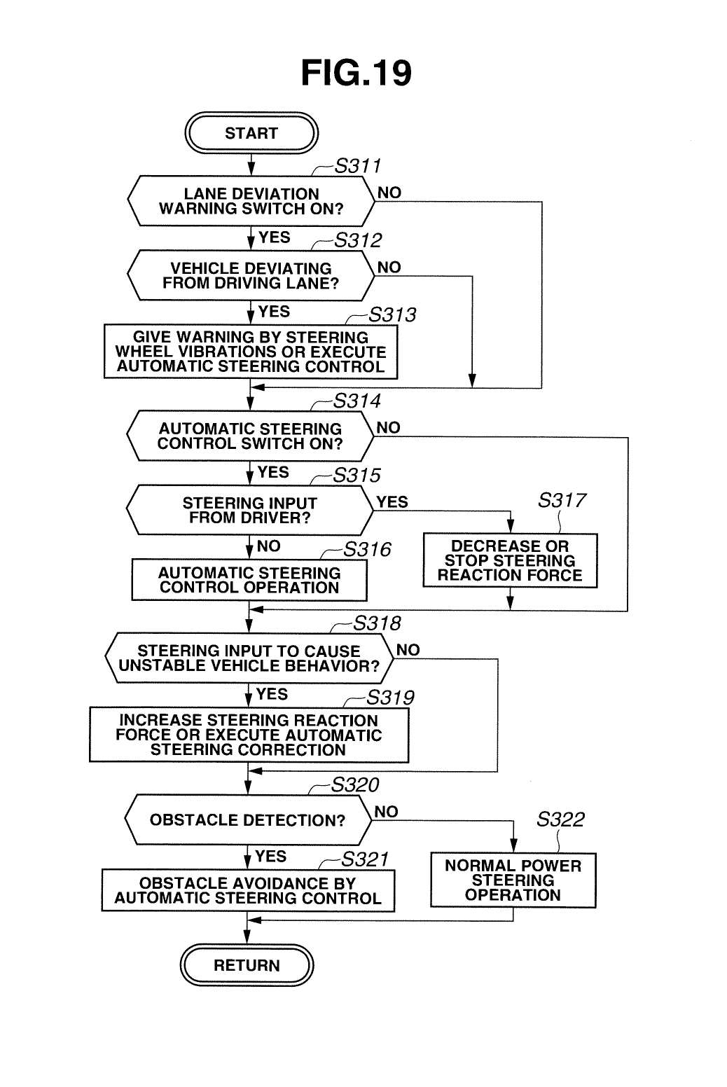

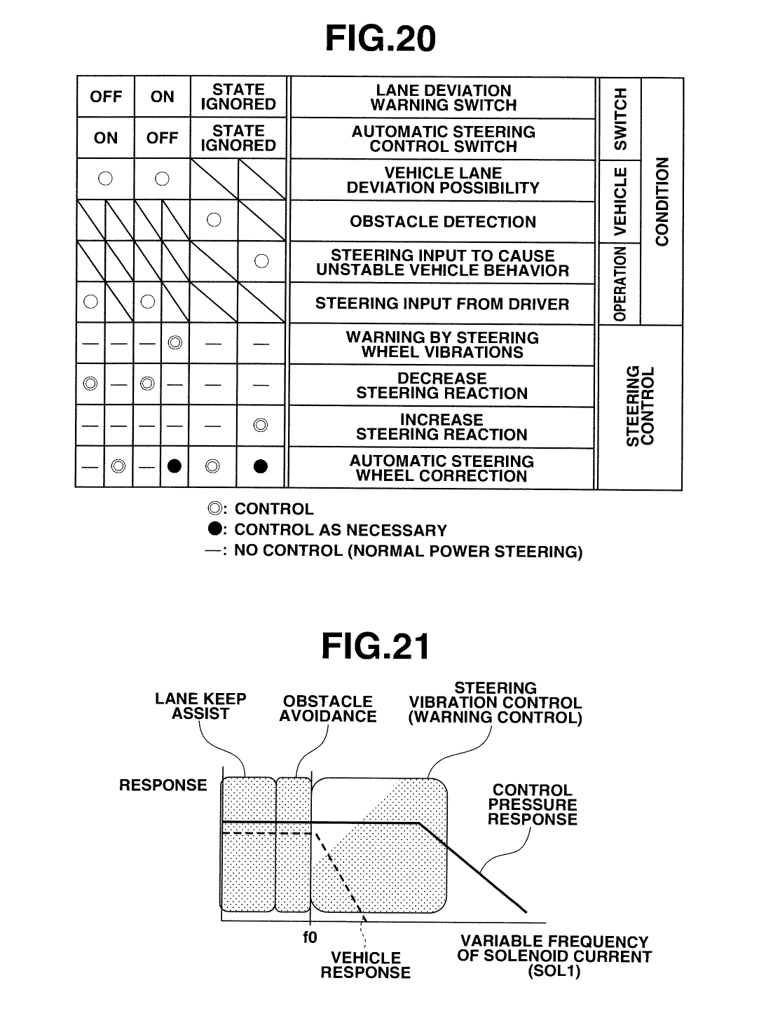

More specifically, the control unit CU judges the demand for automatic steering control (step S3) through an automatic steering control judgment subroutine program of FIG. 19.

### (Lane Keep Assist)

step S311, the control unit CU judges whether the lane deviation warning switch 6f is ON. If Yes at step S311, the program proceeds to step S312. If No at step S311, the program proceeds to step S314.

At step S312, the control unit CU judges whether there is a possibility of the vehicle deviating from the current driving lane based on the signals from the driving lane sensor 6c and the lane deviation warning switch 6f. If Yes at step S312, the program proceeds to step S313. If No at step S312, the program proceeds to step S314.

At step S313, the control unit CU causes the hydraulic control unit 10 to alternately supply the control pressure and the drain pressure to the left and right steering actuators 310 and 320 and thereby vibrate the steering wheel SW by clockwise and counterclockwise rotations of the steering input shaft 4 as a warning to the vehicle driver. Alternatively, the control unit CU runs automatic steering control operation so as to keep the vehicle within the lane. As the hydraulic control unit 10 supplies the hydraulic pressure simultaneously to the steering shaft actuation unit 3 and the control valve 600 as mentioned above, it is possible to produce a steering assist while vibrating the steering wheel SW to warn the vehicle driver of the vehicle deviation. The program then proceeds to step S314.

### (Automatic Steering Control)

At step S314, the control unit CU judges whether the automatic steering control switch 6g is ON. If Yes at step S314, the program proceeds to step S315. If No at step S314, the program proceeds to step S316.

At step S315, the control unit CU judges whether there is a steering operation input by the driver. If Yes at step S315, the program proceeds to step S317. If No at step S315, the program proceeds to step S316.

At step S316, the control unit CU runs automatic steering control operation. In the automatic steering control operation, the torque applied to the steering input shaft 4 by the steering shaft actuation unit 3 is set smaller than the steering torque inputted to the steering input shaft 4 by the driver's steering operation. It is thus possible to prevent the automatic steering control contrary to the driver's steering operation. The program then proceeds to step S318.

At step S317, the control unit CU controls the hydraulic control unit 10 in such a manner that the steering shaft actuation unit 3 decreases the application of the torque to the steering input shaft 4 or terminates the automatic steering control operation. With this, the reaction force against the driver's steering force is decreased or stopped to reduce driver's steering effort. It is thus possible to heed the driver's intention even under the automatic steering control. The program then proceeds to step S318.

### (Vehicle Behavior Stabilization)

At step S318, the control unit CU judges whether there is any steering operation inputted to cause unstable vehicle behavior. If Yes at step S318, the program proceeds to step S319. If No at step S318, the program proceeds to step S320.

At step S319, the control unit CU controls the hydraulic control unit 10 in such a manner that the steering shaft actuation unit 3 increases the application of the torque to the steering input shaft 4. With this, the reaction force against the driver's steering force is increased to limit the steering operation that results in unstable vehicle behavior. Alternatively, the control unit CU may run automatic steering control operation so as to correct the steering direction automatically. The program then proceeds to step S320.

### (Obstacle Avoidance)

At step S320, the control unit CU judges whether there is any obstacle detected. If Yes at step S320, the program proceeds to step S321. If No at step S320, the program proceeds to step S322.

At step S321, the control unit CU runs automatic steering control operation so as to allow the vehicle to avoid the obstacle.

At step S322, the control unit CU runs normal power steering operation.

In the first embodiment, the frequency of the current through the solenoid SOL1 is set to different levels for various control operations such as lane keep assist, obstacle avoidance and steering vibration control (warming control) as shown in FIG. 21. Herein, the control pressure response is set higher than the vehicle response. The frequency of the current to the solenoid SOL1 is set to a high frequency range for steering vibration control (warming control) so as to give a warning to the driver by vibrations of the steering wheel SW with no influence on the vehicle behavior. The frequency of the current to the solenoid SOL1 is set to a low frequency range for lane keep assist so as to steer the vehicle gradually. The frequency of the current to the solenoid SOL1 is set to a middle frequency range immediately near the decrease of vehicle response (at around f0) for obstacle avoidance so as to secure the vehicle response and to steer the vehicle quickly.

The entire contents of Japanese Patent Application No. 2007-272340 (filed on Oct. 19, 2007) are herein incorporated by reference.

Although the present invention has been described with reference to the above-specific embodiments of the invention, the invention is not limited to these exemplary embodiments. Various modification and variation of the embodiments described above will occur to those skilled in the art in light of the above teachings.

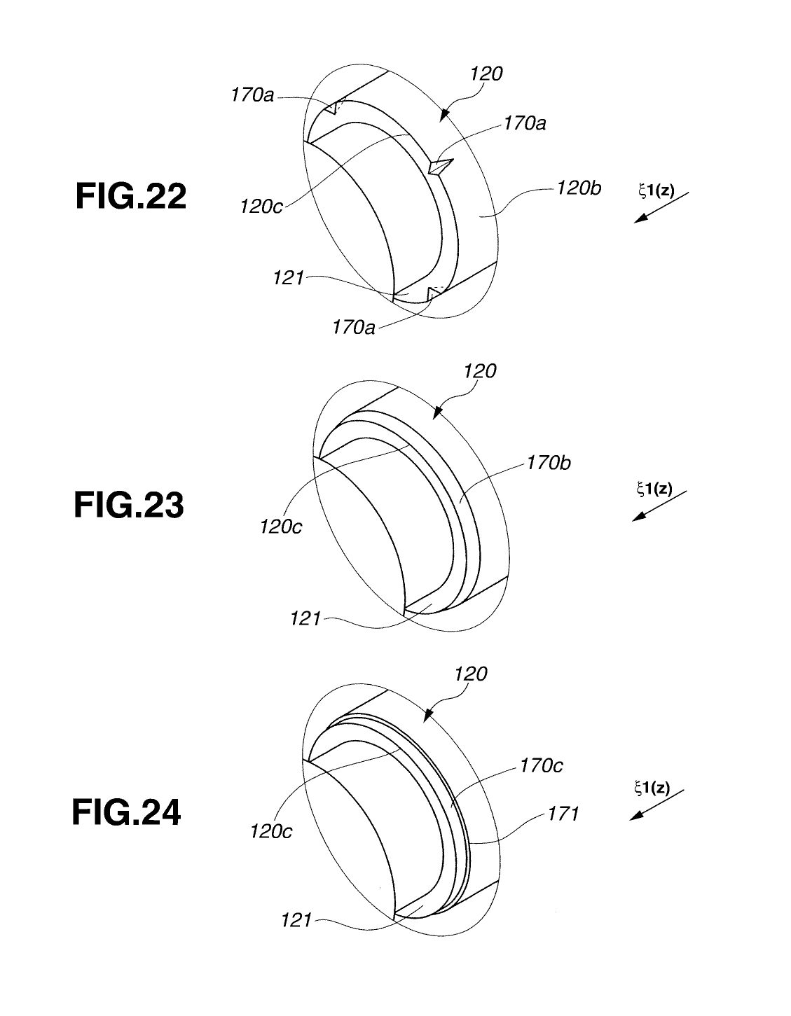

For example, the spool 120 of the pressure regulation valve 100 may have a chamfered section formed by cutting V-shaped grooves 170a in the edge of the step 120c as shown in FIG. 22, a chamfered section 170b formed by cutting off the edge of the step 120c as shown in FIG. 23, or a chamfered section 170c formed with a step 171 as shown in FIG. 24.

The scope of the invention is defined with reference to the following claims.

What is claimed is:

1. A power steering apparatus, comprising:
a steering shaft connected to a steering wheel;
a hydraulic power cylinder connected to the steering shaft and having first and second hydraulic chambers;
a hydraulic pump that discharges a hydraulic pressure to the power cylinder;
a control valve that supplies the hydraulic pressure from the pump to the first and second hydraulic chambers selectively in response to a steering operation of the steering wheel;
a steering shaft actuation unit driven by the hydraulic pressure from the pump to apply a torque to the steering shaft;
a detection unit that detects information about at least one of a vehicle, a driver or a road; and
a hydraulic control unit that supplies the hydraulic pressure from the pump to either of the control valve and the steering shaft actuation unit in accordance with the detected information,
the hydraulic control unit being so structured as to, at the supply of the hydraulic pressure to the steering shaft actuation unit, increase the hydraulic pressure discharged from the pump to be supplied to the steering shaft actuation unit.

2. The power steering apparatus according to claim 1, wherein the hydraulic control unit has a spool valve mechanism.

3. The power steering apparatus according to claim 2, wherein the hydraulic control unit allows the supply of the hydraulic pressure to the control valve simultaneously with the supply of the hydraulic pressure to the steering shaft actuation unit.

4. The power steering apparatus according to claim 2, wherein a spool of the spool valve mechanism has a land formed with a chamfered section on an axial end thereof.

5. The power steering apparatus according to claim 2, wherein the spool valve mechanism has a hydraulic passage to always provide a communication between the pump and the control valve.

6. The power steering apparatus according to claim 1, wherein the hydraulic control unit provides a communication between the pump and the control valve in the event of a failure in the hydraulic control unit.

7. The power steering apparatus according to claim 6, wherein the steering shaft actuation unit comprises left and right steering actuators; the hydraulic control unit comprises first and second solenoid valves; the first solenoid valve regulates the supply of the hydraulic pressure from the pump to either the control valve or the second solenoid valve; and the second solenoid valve regulates the supply of the hydraulic pressure from the first solenoid valve to either of the left and right steering actuators.

8. The power steering apparatus according to claim 7, wherein the first solenoid valve provides a communication between the pump and the control valve in a de-energized state.

9. The power steering apparatus according to claim 6, wherein the steering shaft actuation units comprises left and right steering actuators; and the hydraulic control unit comprising a solenoid valve that has a first operation position to supply the hydraulic pressure from the pump to the control valve, a second operation position to supply the hydraulic pressure to the left steering actuator and a third operation position to supply the hydraulic pressure to the right steering actuator.

10. The power steering apparatus according to claim 1, wherein the hydraulic control unit decreases the torque applied by the steering shaft actuation unit when the detection unit detects the steering operation made by the driver.

11. The power steering apparatus according to claim 1, wherein the torque applied by the steering shaft actuation unit is smaller than a steering torque inputted by the driver.

12. The power steering apparatus according to claim 11, wherein the hydraulic control unit comprises a spool valve mechanism that has an axial pin hole formed with a bearing surface and a pin slidably inserted in the pin hole and formed with a bearing surface opposing the bearing surface of the pin hole and establishes or interrupts a communication between the pin hole and the pump so as to exert the hydraulic pressure from the pump onto the bearing surfaces of the pin and the pin hole.

13. A power steering apparatus, comprising:
a steering shaft connected to a steering wheel;
a hydraulic power cylinder connected to the steering shaft and having first and second hydraulic chambers;
a hydraulic pump that discharges a hydraulic pressure to the power cylinder;
a control valve that supplies the hydraulic pressure from the pump to the first and second hydraulic chambers selectively in response to a steering operation of the steering wheel;
a steering shaft actuation unit driven by the hydraulic pressure from the pump to apply a torque to the steering shaft;
a detection unit that that detects information about at least one of a vehicle, a driver or a road; and
a hydraulic control unit that supplies the hydraulic pressure from the pump to either of the control valve and the steering shaft actuation unit in accordance with the detected information,
the hydraulic control unit narrowing down a hydraulic passage for communication to the control valve at the supply of the hydraulic pressure to the steering shaft control unit.

14. The power steering apparatus according to claim 13, wherein the hydraulic control unit has a spool valve mechanism.

15. The power steering apparatus according to claim 14, wherein the hydraulic control unit allows the supply of the hydraulic pressure to the control valve simultaneously with the supply of the hydraulic pressure to the steering shaft actuation unit.

16. The power steering apparatus according to claim 13, wherein the hydraulic control unit provides a communication between the pump and the control valve in the event of a failure in the hydraulic control unit.

17. A power steering apparatus, comprising:
a steering shaft connected to a steering wheel;
a hydraulic power cylinder connected to the steering shaft and having first and second hydraulic chambers;
a hydraulic pump that discharges a hydraulic pressure to the power cylinder;
a control valve that supplies the hydraulic pressure from the pump to the first and second hydraulic chambers selectively in response to a steering operation of the steering wheel;
a steering shaft actuation unit driven by the hydraulic pressure from the pump to apply a torque to the steering shaft;
a detection unit that detects information about at least one of a vehicle, a driver or a road; and
a hydraulic control unit that supplies the hydraulic pressure from the pump to either of the control valve and the steering shaft actuation unit in accordance with the detected information,
the hydraulic control unit having a first hydraulic passage for communication to the steering shaft actuation unit and a second hydraulic passage for communication to the control valve and being capable of controlling the cross-sectional areas of the first and second hydraulic passages individually in such a manner that the cross-sectional area of the first hydraulic passage is made larger than the cross-sectional area of the second hydraulic passage at the supply of the hydraulic pressure to the steering shaft actuation unit.

18. The power steering apparatus according to claim 17, wherein the hydraulic control unit has a spool valve mechanism.

19. The power steering apparatus according to claim 18, wherein the hydraulic control unit allows the supply of the hydraulic pressure to the control valve simultaneously with the supply of the hydraulic pressure to the steering shaft actuation unit.

20. The power steering apparatus according to claim 17, wherein the hydraulic control unit provides a communication between the pump and the control valve in the event of a failure in the hydraulic control unit.
